(19) United States
(12) Patent Application Publication
(10) Pub. No.: US 2025/0351942 A1
(43) Pub. Date: Nov. 20, 2025

(54) DOUBLE-LAYER MOLD FOR MACHINES FOR PRODUCTION OF LIPSTICKS OR THE LIKE, AND RELATED MANUFACTURING PROCESS

(71) Applicant: INTERCOS S.p.A., Milano (IT)

(72) Inventors: Giuseppe LATTANZI, Limbiate (IT); Christian COTTONE, Cavenago di Brianza (MB) (IT)

(21) Appl. No.: 18/872,138

(22) PCT Filed: Jun. 1, 2023
(86) PCT No.: PCT/EP2023/064638

§ 371 Date: Dec. 5, 2024

(30) Foreign Application Priority Data
Jun. 13, 2022 (IT) 102022000012437

(51) Int. Cl. A45D 40/16; B29C 33/38

(52) U.S. Cl. CPC A45D 40/16; B29C 33/3842

(57) ABSTRACT

A mold (1) for machines for production of lipsticks or similar bar-shaped cosmetic products is formed with two coaxial layers (5, 6) of different chemically linked silicones, of which an inner layer (5) of smaller thickness in hard silicone and an outer layer (6) of greater thickness in soft silicone.

The present invention relates to a double-layer mold usable for machines for producing lipsticks or similar bar-shaped cosmetic products, and the related manufacturing process.

As known, the manufacture of lipsticks or similar cosmetic products provides the use of machines having cavities of thermally rigid and mechanically resistant material, each of which is internally lined with a hollow ogive-shaped mold of malleable plastic material with inner cavity of complementary shape to that desired for the outer surface of the lipstick. The introduction of an appropriate amount of cosmetic composition inside said cavity results in the formation of a lipstick (or similar cosmetic product) of the desired shape which, once cooled, is extracted from the mold.

Ogive-shaped molds are known for the aforesaid use, which are made of a silicone that has the dual need of being sufficiently rigid to withstand the mechanical stresses to which the mold is subjected during the production of the cosmetic product and at the same time flexible enough to allow the lateral enlargement or opening of the mold by means of the creation of a vacuum for the extraction of the cosmetic product therefrom.

Unfortunately, the standard silicone currently used for the manufacture of such molds is subject to mechanical wear even after a few filling cycles (also according to the ingredients comprised in the formula of the chemical filling composition) and this forces the lipstick manufacturers to replace the molds often to allow compliant productions and minimize production waste.

An object of the present invention was to make a mold of silicone material which was capable of fully satisfying the two above-mentioned requirements.

According to the present invention, such an object has been achieved by means of a mold characterized in that it is formed by two coaxial layers of different chemically linked silicones, of which an inner layer of smaller thickness in hard silicone and an outer layer of greater thickness in soft silicone.

With respect to traditional single-layer molds, the inner layer of the mold according to the invention increases the resistance of the mold to mechanical wear, improves the heat exchange and resistance to chemical agents present in the lipstick formula and also gives greater shine to the surface of the lipstick, while the outer layer makes it possible to open the mold by means of the traditional vacuum creation of existing machines.

For the manufacture of a double-layer mold according to the present invention, a process is advantageously envisaged which includes introducing a male element inside a first cavity so as to form a first space with shape and size corresponding to those of the inner layer of the mold being produced, introducing a first fluid silicone material inside said first space to form a mold inner layer, cooling said mold inner layer until it adheres to said male element, extracting said male element with adherent mold inner layer from said first cavity, introducing said male element with adhered mold inner layer inside a second cavity of greater size than said first cavity so as to form a second space with shape and size corresponding to those of the outer layer of the mold being manufactured, introducing a second fluid silicone material into said second space to form a mold outer layer chemically linked to said mold inner layer so as to form a double-layer mold, cooling said double-layer mold, extracting said male element from said double-layer mold while holding said double-layer mold inside said second cavity, and extracting said double-layer mold from said second cavity.

The features of the double-layer mold according to the present invention and of the related manufacturing process will be made more evident by the following detailed description of an embodiment thereof shown by way of non-limiting example in the accompanying drawings, in which:

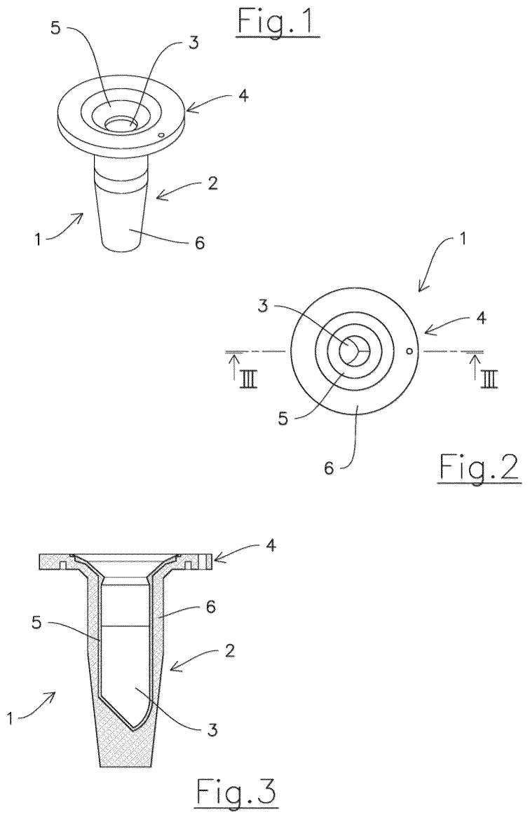

FIG. 1 shows a double-layer mold in perspective view;

FIG. 2 shows the same mold in plan from above;

FIG. 3 shows the mold in axial section according to line III-III of FIG. 2;

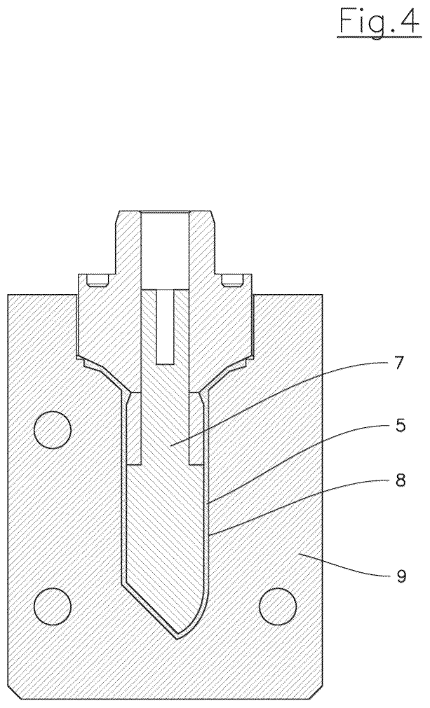

FIGS. 4-7 show a sequence of manufacturing steps of the double-layer mold.

The double-layer ogive-shaped mold shown by way of example in FIGS. 1-3, where it is indicated as a whole with the number 1, has a hollow main body 2 of approximately frustoconical outer shape with an inner cavity 3 which is open above and closed below, the shape of which corresponds to the outer shape of the lipstick or other cosmetic product for the production of which the mold 1 is intended. The main body 2 ends above with a flat flange 4.

As clearly highlighted in FIG. 3, the mold 1 is formed by a thin inner layer 5 of smaller thickness and by an outer layer 6 of greater thickness, chemically linked to each other. The thickness of the inner layer 5 can for example be 1 mm, while the thickness of the outer layer 6 can for example be 2 mm. The inner layer 5 is made of a hard and rigid silicone material (preferably with hardness ShA 20/25), while the outer layer 6 is made of a soft silicone material (preferably with hardness ShA 10/12).

Advantageously, the manufacturing process of the mold 1 with inner layer 5 and outer layer 6 follows the modes shown in FIGS. 4-7.

In particular, a male element 7 is introduced inside a cavity 8 of a mold 9 so as to define a space of shape and size equal to those desired for the inner layer 5 of the mold 1. A first suitable fluid silicone material is introduced inside such a space and then cooled so as to form a thin hard and rigid ogive-shaped layer 5 adhering to the male element 7 (FIG. 4).

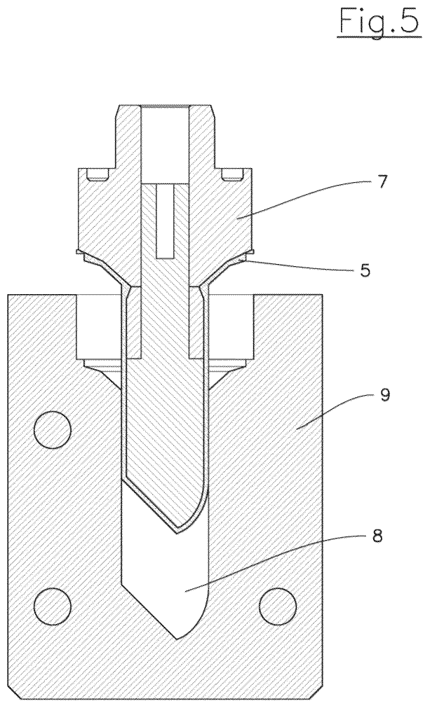

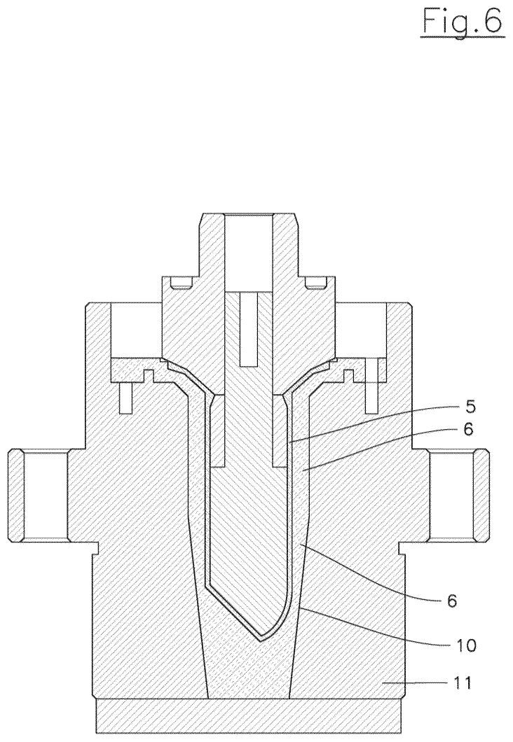

The male element 7 with adherent layer 5 is then extracted from the mold 8 (FIG. 5) and subsequently introduced together with the layer 5 inside a wider cavity 10 of a rigid mold 11 so as to define a second space of shape and size equal to those desired for the outer layer 6 of the mold 1. A second suitable fluid silicone material is introduced inside such a second space and then cooled so as to form a thick, soft, ogive-shaped layer 6 which is chemically linked to the layer 5 adhered to the male element 7 (FIG. 6).

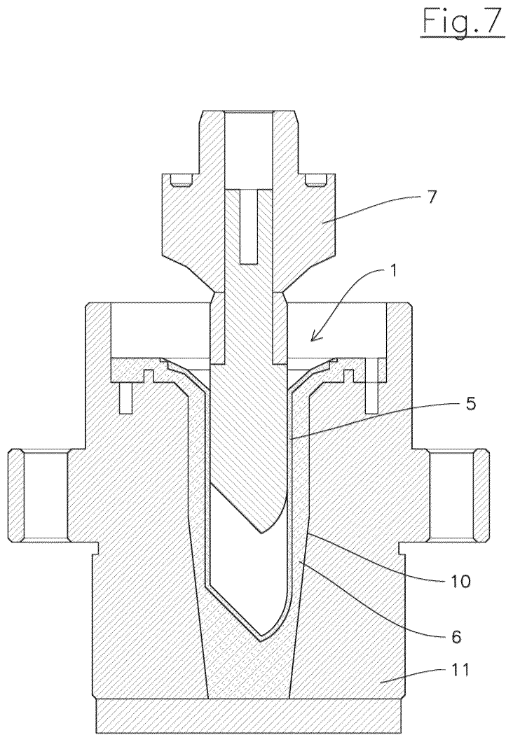

The male element 7 is then extracted from the rigid mold 11 where instead the two layers 5 and 6 (FIG. 7) remain, held by means of the formation of a pneumatic vacuum outside the cavity 10 (a technique in itself known in the machines of the field). Removing the vacuum, an ogive-shaped mold 1 with two coaxial layers 5 and 6 forming a single body, such as that of FIGS. 1-3, can finally be extracted from the mold 11.

1. Mold (1) for machines for production of lipsticks or similar bar-shaped cosmetic products, characterized by being formed by two coaxial layers (5, 6) of different chemically linked silicones, wherein an inner thinner layer (5) is made of hard silicone and an outer thicker layer (6) is made of soft silicone.

2. Process for manufacturing a mold (1) with two coaxial layers (5, 6) according to claim 1, comprising, in succession, introduction of a male element (7) into a first cavity (8) to form a first space with shape and size corresponding to those of the inner layer of the mold being manufactured, introduction of a first fluid silicone material into said first space to form a mold inner layer (5), cooling of said mold inner layer (5) until adhering to said male element (7), extraction of said male element (7) with adhered mold inner layer (5) from said first cavity (8), introduction of said male element (7) with adhered mold inner layer (5) into a second cavity (10) of greater size than said first cavity (8) to form a second space with shape and size corresponding to those of the outer layer of the mold being manufactured, introduction of a second fluid silicone material into said second space to form a mold outer layer (6) chemically linked to said mold inner layer (5) so as to constitute a mold (1) with double layer (5, 6), cooling of said mold (1) with double layer, extraction of sail male element (7) from said mold (1) with double layer while holding said mold (1) inside said second cavity (10), and extraction of said mold (1) with double layer (5, 6) from said second cavity (10).
